(19) United States
(12) Patent Application Publication
(10) Pub. No.: US 2012/0215738 A1
(43) Pub. Date: Aug. 23, 2012

(54) SYSTEM AND METHODS FOR THE MANAGEMENT, STRUCTURING, AND ACCESS TO A LEGAL DOCUMENTS DATABASE

(75) Inventor: Daniel R. Wilton, Ottawa (CA)

(73) Assignee: TOLOGIX SOFTWARE INC., Ottawa (CA)

(21) Appl. No.: 13/402,110

(22) Filed: Feb. 22, 2012

Related U.S. Application Data
(60) Provisional application No. 61/445,748, filed on Feb. 23, 2011.

(51) Int. Cl. G06F 17/30

(52) U.S. Cl. 707/608; 707/E17.008

(57) ABSTRACT

Systems and methods for management, structuring, and access to a legal document database. A single database of documents is accessible by a number of access servers for providing access to these documents for users. The documents and their contents are tagged and classified for ease of reference. Documents and sections of documents are tagged against specific topics and concepts. The topics are presented to users in a structured manner and are cross-referenced against relevant and related topics. A user can thus quickly access not just the most relevant documents but the most relevant sections of those documents when researching a topic.

The present application claims the benefit of priority of U.S. Provisional Patent Application No. 61/445,748 filed 23 Feb. 2011, which is hereby incorporated by reference

### TECHNICAL FIELD

The present invention relates to databases and, more specifically, relates to a database of legal documents accessible by multiple servers.

### BACKGROUND OF THE INVENTION

The increasing ease by which documents are being digitized and the increasing need for searchable databases have been fuelled by expectations due to faster processors and storage devices.

Unfortunately, the greater the size of the database, the seemingly harder it is to find relevant documents or relevant passages in documents. Since documents are now more and more accessible, this inability to locate what is being searched for coupled with the increasing number of documents threatens to bury humanity in data.

Databases of documents have been used in the past but these have, generally, been incapable of being searched by their content nor by nuances based on that content. As well, databases which are indexed by topic and which are cross-referenced by relevance to specific key words or topics are currently unknown or unwieldy to use.

There is therefore a need for systems, methods, and databases which overcome or mitigate the shortcomings of the prior art.

### SUMMARY OF INVENTION

The present invention provides systems and methods for managing and accessing a database of legal documents. A single database of documents is accessible by a number of access servers for providing access to these documents for users. The documents and their contents are tagged and classified for ease of reference. Documents and sections of documents are tagged against specific topics and concepts. The topics are presented to users in a structured manner and are cross-referenced against relevant and related topics. A user can thus quickly access not just the most relevant documents but the most relevant sections of those documents when researching a topic.

In a first aspect, the present invention provides a system for managing and accessing a plurality of documents by way of an interconnected network of computers, the system comprising:
a plurality of groups of access servers, each group of access servers being for providing access to organized documents to different groups of subscribing users
a single storage database for storing said documents, said single database being accessible by each of said groups of access servers
   wherein
a plurality of said documents being tagged to identify specific sections of said documents said sections being relevant to various topics of research for said subscribing users

In a second aspect, the present invention provides a system for managing and providing access to a plurality of documents for a plurality of users, the system comprising:
a presentation subsystem for displaying a user interface to users
a data subsystem for storing and managing a database of said plurality of documents
a data access subsystem for processing data and documents retrieved from said data subsystem prior to being forwarded to said presentation subsystem
a business based subsystem for retrieving and modifying documents and data from said data subsystem and for forwarding said documents and data to said data access subsystem
   wherein
a plurality of said documents being tagged to identify specific sections of said documents, said sections being relevant to various topics of research for said users

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2 is a block diagram of another system according to another aspect of the invention;

FIG. 3 is a screenshot of a subject navigator as implemented according to one aspect of the invention;

FIG. 4 is a screenshot of an article citator as used in one implementation of an aspect of the invention;

FIG. 5 is a screenshot of a jurisprudence citator according to another aspect of the invention;

FIG. 6 is a screenshot of a sample search result using a “Terms & Phrases” module used in the system according to another aspect of the invention;

FIG. 7 is a screenshot of the user interface for the Treaties & Rules module of the system;

FIG. 8 is an illustration of a sample annotated agreement as used in the system;

FIGS. 9 and 10 are screenshots of the user interface for the Dispute Documents portion of the system;

FIGS. 11, 12, and 13 are screenshots of the user interface for editing tools for the module that allows administrator users to add documents to the database; and

FIG. 14 is a screenshot for the Document Database component of the system.

### DETAILED DESCRIPTION OF THE INVENTION

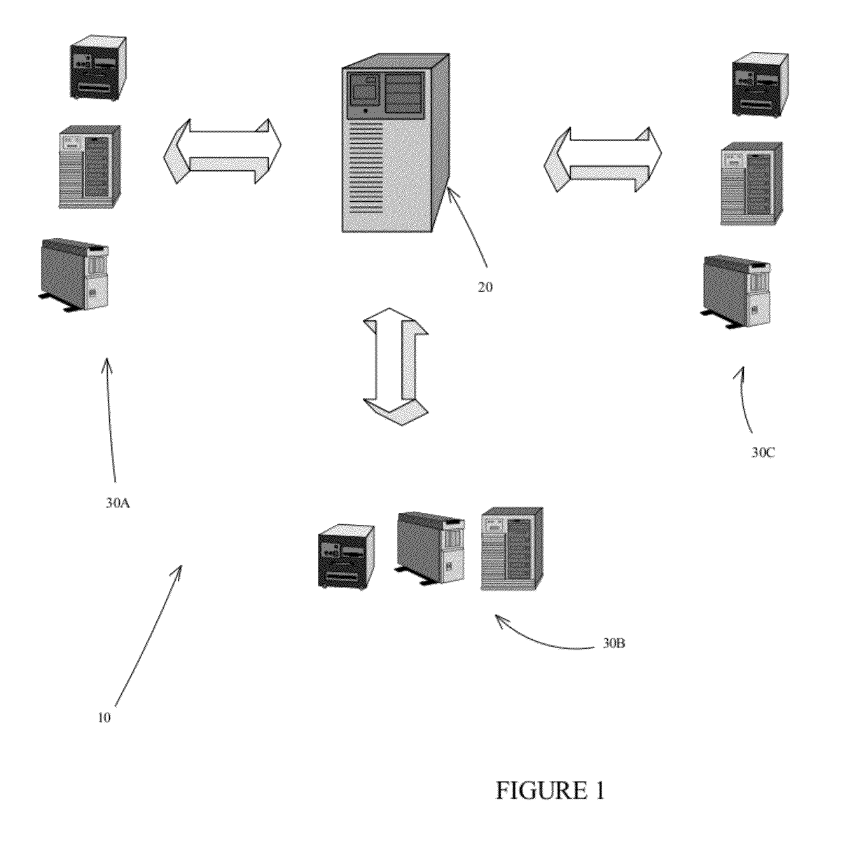

Referring to FIG. 1, a block diagram of one implementation of an aspect of the invention is illustrated. As can be seen, the system 10 has a database 20. The database 20 is accessed by a first group of access servers 30A, a second group of access servers 30B, and a third group of access servers 30C. Each access server in the various groups of access servers are used by different users to access documents 40 in the database 20.

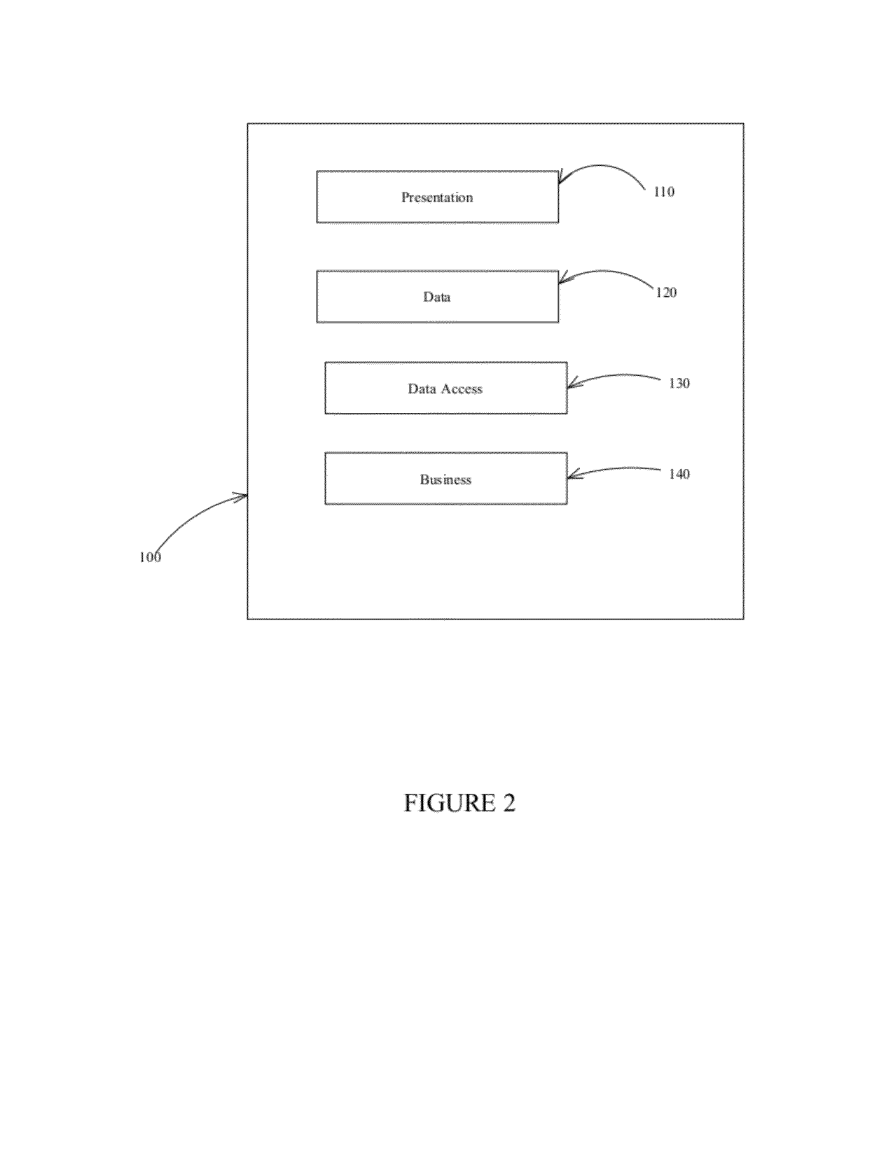

It should be noted that at least one of the servers in the groups 30A-30C has an internal application structure as illustrated in FIG. 2. As can be seen, the server 100 has a number of subsystems, a presentation subsystem 110, a data subsystem 120, a data access subsystem 130, and a business based subsystem 140.

In one implementation of the invention, the system 10 is used as an online legal research database. The online legal research database permits subscriber users to access to subject specific articles, documents (PDF or Text), terms and phrases, as well as content summaries for international areas of law. As well as a database for use in international law, the database is also accessed as part of an investor state law database.

The implementation operates in a formal framework following ASP.NET MVC, with the use of JQuery/AJAX on the GUI layer, the use of web services for integration as an API, as well as the use of other web-based technologies. This implementation allows extensibility, scalability, and serviceability of client sites.

For this implementation of the invention, the system is used as a legal research database, an ASP/SaaS based tool for members/users to securely access centralized databases for specialty areas of law. The subject matter content is structured and organized under various topics & categories so that members/users can easily locate content they require. Users can refer to past cases, view latest rules and updates, as well as search for various types of contents & documents.

Searches on the database are modular and Ajax-based, with auto complete features so users, while typing search parameters, can view corresponding suggested results from the pre-structured components or indexes. Full text searches may also be performed using an integrated third party full text search application, where filters relating to components of the dataset can be added, as well as contextual and suggestive results.

The database is maintained using a secure backend administrative interface. Administrator users have role-based access where the main administrator will assign permissions to them. Staff or administrator users can access the data & features assigned to them, and where workflow-based approval of contents & data occur.

Using the database, subscribing members can access a research compendium that applies expert knowledge and structured information alongside familiar search tools. Such information is presented in a comprehensive fashion that permits intuitive access to key components of a particular body of knowledge. Information is presented with suggestive elements, and within multiple dimensions and granularity that permit access from multiple viewpoints.

Using a web-enabled interface, non-technical administrator users (e.g., lawyers, data entry and other support staff) can upload content to the database. These same users can maintain content by following an intuitive workflow process to modify, update and revise all elements of publicly available data, website content, and user permissions. With strict policy management protocols, only persons authorized to alter the content of the database have access via the administrative tools, where audit trails are maintained.

The user/subscriber side of the system has a modular architecture which enables a user to utilize a methodical approach when researching legal jurisprudence, while providing an efficient means to improve the comprehensiveness of the research.

The top-level navigational design of the system allows: (i) the ability to find content specific to the company (e.g. help, contact, profile, logout, etc) to permit ease-of-use of the research tools, and (ii) logically grouped navigation for the website, grouped in a top level navigational hierarchy, by the type of content presented.

The subscriber side is structured in a modular manner that permits users (typically researchers, lawyers, subject matter experts) the ability to follow logical steps when conducting legal research.

The user interface for the system has a “Research Tools” tab that contains the core research tools specific to the body of knowledge, organized from left to right with the following tools/options in the menu bar:

(i) Subject Navigator—displays highly structured and organized subject matter as an encyclopedia of knowledge, in an inter-related hierarchy of context. The subjects are predetermined and serves as a gateway to the specific provisions legal agreements, instruments, and other related subject matter of the database in a meaningful way.
(ii) Article Citator—permits users to “note up” specific provisions of legal instruments and agreements. This option allows users to receive data showing which cases, agreements, and other documents reference or relate to these specific provisions. Information is displayed with pinpoint references (use of inline frames that call and display specific points of a specifically coded or tagged PDF file) to call and display specific components of agreements as well as all corresponding references to that particular provision.
(iii) Jurisprudence Citator—displays information with similar pinpoint access (including use of inline frames that call and display specific points of a specially tagged or coded PDF file) allowing users to ascertain how decisions and awards have been considered by legal bodies, enabling users to further “note up” references to such jurisprudence. This capability allows users to see how specific concepts, ideas, and provisions in agreements, treaties, and legislation have been considered by tribunals and other relevant decision making entities.
(iv) Terms & Phrases—displays specific terms and phrases with context, as defined in legal documents or as elaborated upon in jurisprudence. This tool is helpful in identifying terms and phrases that may be applicable across different legal instruments.
(v) Full Text Search—this tool provides advanced full text search features that permit deep and comprehensive searching of the data collection following boolean logic. In one implementation, the system uses a similar third party full text search application as noted above.

In this implementation, the user interface also has a “Treaties & Rules” tab which contains secondary reference content specific to the body of knowledge, organized in a category format starting with “All” (showing all the categories) and then following with grouped subject matter for easier filtering and display. The tab can also be used for other secondary references for implementations that do not use treaties or rules as secondary references. As part of this tab, the following options are available:

(i) “All” displays the legal agreements in an “Annotated” and/or “Non-Annotated Text” format that is derived from XML uploaded content (via the administrator system) and with accompanying PDF source files in a web-based format.
(ii) “Group1, Group2, etc.” are groupings by which the various documents are grouped in the tabbed menu system. In one implementation, the documents are grouped according to the subject matter of the documents. The subject matter of a document can be determined when it is uploaded to the system via the administration system.

Also present in the menu system is a “Dispute Documents” tab which also contains secondary reference content. This tab, in this implementation, provides users with access to the entire collection of dispute documents currently available in the database.

The list of documents is displayed in the directory table at the bottom of the screen and can be filtered according to predetermined document categories. These predetermined document categories are determined for each document as part of the upload process. As noted above, the document category is also part of the grouping in the grouping tab mentioned above. The directory table also provides the user with information relevant to the document and the underlying dispute, such as the document date, the applicable legal instrument specific to a body of knowledge with links to such source content.

In other implementations of the system, the tab for secondary references may also provide similar functionality to the “Dispute Documents” tab. Secondary references may be grouped according to their subject matter and may have their document information (e.g. information relating to what is in the document) listed in a directory style listing on the user interface.

As noted above, a “Research Tools” tab is present in the user interface. This may be implemented using a module specifically for the various tools accessible via the Research Tools tab. This module may have different submodules, a number of which are described below.

A subject navigator submodule is used in one implementation of the system. Using the administration system, the navigator is built using predetermined subjects and serves as a gateway to the specific subjects, provisions and issues of legal agreements, instruments, and other related subject matter of a constructed database. The subjects may, depending on the implementation, be predetermined after consultations with an expert in the subject matters of the documents in the database.

The navigator uses a taxonomy based tree and information is indexed in this tree. For complex subject matters, information is presented in the form of a multi-faceted electronic encyclopedia which cross-references topics within the Subject Navigator.

As an example of the above, in one implementation, the “Standard of Treatment” concept is noted in the subject navigator of an international law database. The user is provided with results specific to legal instruments (such as NAFTA Articles) as well as discussions of where the subject originated (e.g. which NAFTA articles refer to the concept, which cases mention the concept, etc.) along with details regarding the documents referred to in the discussions. The details regarding the documents may include the headnotes for the specific cases, the entities involved in the cases, the date of the decision, the specific article referred to in the treaty/agreement, the title of the specific article referred to, the section heading for the specific article, as well as other identifying information. Of course, hyperlinks to the documents themselves are provided to the user so that the user may access the source material himself.

The tools in the subject navigator follow a hierarchical tree structure, where the predetermined taxonomy displays issues and concepts in a highly meaningful way, grouping together, linking, and cross-referencing content to permit users to launch into other tools with a single view.

A subscriber will select a letter from the vertical list by clicking on the + symbol (e.g., “E”), then selects a subject of interest (e.g., “Expropriation”) by clicking on the + beside the topic. Each subject is organized by branch and sub-branch(es) further expanding the subheadings for more specific information. If, however, a users wants to know how the Subject Navigator treats a subject ‘generally’ the users can click on the “+All” link beside the word at the top of the branch, to open all of the branches and sub-branches for that specific subject. The subjects are, for ease of reference, listed in a nested, hierarchical tree structure so that users will know how deep into the tree structure he or she is delving for a specific topic.

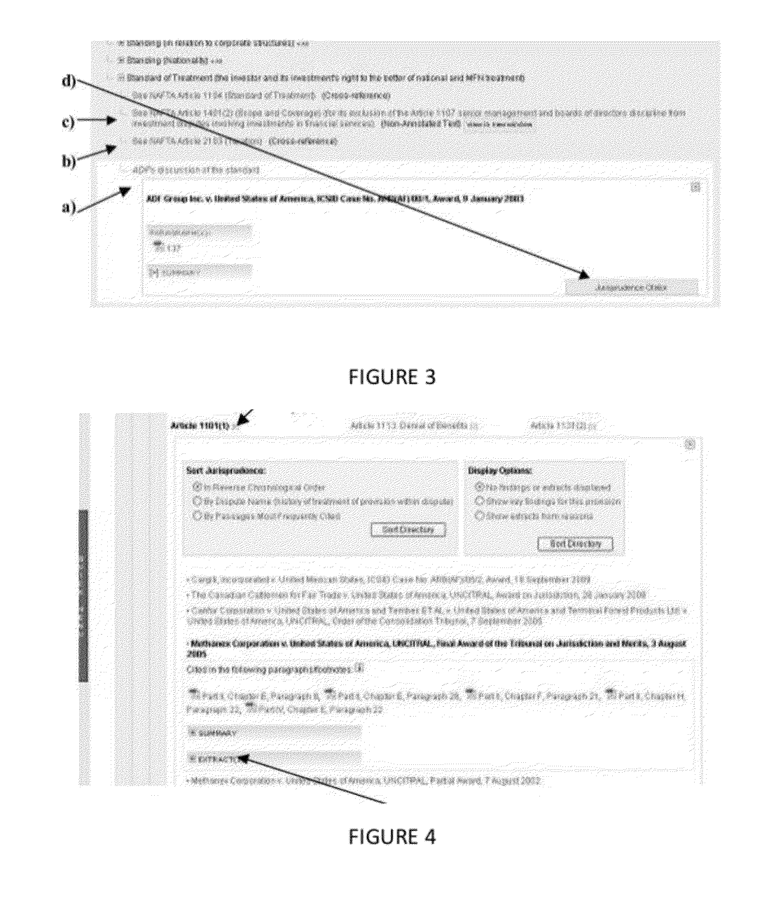

Referring to FIG. 3, the following interface features relate to the types of links as identified as a), b), c), d) in the Figure:

a) Making use of inline presentation and viewing tools that link to content from an article citator tool (such as specific paragraphs, summaries, and related information).
b) cross-references (e.g. links that are internal the Subject Navigator directory) to other listings with similar or relevant subject matter as the category discussed.
c) links to the XML text versions of the annotated and non-annotated content/document as found in the specific legal instruments and as part of the Treaties & Rules tab or as part of another secondary resource tab
d) related, contextual information from the Jurisprudence Citator (e.g. clicking on the “Jurisprudence Citator” link on the right hand side as in the Figure, and as part of the “ADF's discussion of the standard” as found within the Navigator brings the user to the Jurisprudence Citator entry—see below). This can be presented as part of the subject content to provide insight into how the cases were cited and how they were treated by subsequent courts/tribunals. This feature may be of particular use for databases of documents where the subject matter of the documents relate to or are dependent upon specific content from other documents in the database. For ease of implementation, the result within the Subject Navigator when the Jurisprudence Citator is used is the same as the entry within the Jurisprudence Citator itself for that particular case. This is because this is where the content originates on upload via the administration system. Instead of implementing another submodule, activating the Jurisprudence Citator within the Subject Navigator merely calls the Jurisprudence Citator module.

In addition to the subject navigator submodule, an article citator submodule may also form part of the “Research Tools” tab.

This tool implemented by such a submodule permits users to “note up” specific provisions of legal instruments and agreements. Information is displayed with pinpoint references (using inline frames that call and display specific points of a specially encoded/tagged PDF file) that display specific components/provisions (e.g. sections and categories) of agreements along with the corresponding references to that particular provision (e.g. if there is a number indicated in square brackets, it signifies the number of decisions or awards that reference that specific provision of the agreement). The information in the Article Citator is more accurate than a full text search because it accounts for all of the different ways a provision can be referenced. Furthermore, the Article Citator is more precise than a full text search since it only provides references to provisions in the context of specific findings by a court/tribunal. As an example, the Article Citator may exclude results that are references to provisions in summaries of procedure and party submissions to reduce subjectivity.

In addition to the specific references of the provision and related jurisprudence, concise summaries of the main findings, and text extracts from decisions or awards concerning interpretative findings by courts/tribunals are captured and displayed by the Article Citator in an intuitive fashion by making use of collapsible tables, as well as inline frames for pinpoint PDF browsing.

Different filters can be used to sort the jurisprudence in question by clicking on the inline options as identified above. Additionally, there is an option at the top of the section of the agreement to “List of jurisprudence referring to this agreement or instrument” where all related jurisprudence can be displayed as an interactive list and report. This option provides the user with all jurisprudence in the database relating to the specific provision/article. Other implementations for such a tool may retrieve all documents relating to a specific concept/article being researched. As can be imagined, the tool would take advantage of the tags associated with the various documents in the database.

A sample screenshot of the Article Citator is provided in FIG. 4.

A further submodule that may be part of the Research Tools tab is the Jurisprudence Citator. This tool displays information with similar pinpoint access (including use of inline frames that call and display specific points of a specially tagged/coded PDF file) allowing users to ascertain how decisions and awards have been considered by legal bodies, enabling users to further “note up” references to such jurisprudence. These tools show whether, where, and how particular legal decisions and awards have been subsequently considered. Citations for individual documents can be viewed by clicking on the relevant dispute name or category.

For each jurisprudence cited document, users can view the following (these options are provided as part of the user interface for this tool):

(i) [+] Summary related content on the jurisprudence in a collapsible window—the content may be headnotes regarding the jurisprudence.
(ii) “All references to this decision or award”-citations that refer to a decision generally (without specifying a paragraph or footnote of the document) includes both general references to a decision or award and references to specific paragraph(s), page(s) or footnote(s).
(iii) “References to specific paragraphs/pages & footnotes of this award or decision”—includes only citations to a particular paragraph, page or footnote of a decision or award.

In this particular implementation, the Jurisprudence Citator module has three categories, consisting of the NAFTA Jurisprudence Citator Investment, Treaty Jurisprudence Citator and Non-Investment Treaty Jurisprudence Citator all with their own content but same general features for search/display. Other implementations may use other categories. These categories may, depending on the implementation, be sub-categories of the main category. As with the specific implementation explained above, the NAFTA Jurisprudence Citator, Treaty Jurisprudence Citator, etc. are sub-categories of the main Jurisprudence Citator. Multiple sub-categories may be used for other implementations.

An example of the user interface and sample results from the Jurisprudence Citator is illustrated in FIG. 5.

A further submodule in addition to the above is the “Terms & Phrases” submodule. This tool displays specific terms and phrases with context, as defined in legal documents or elaborated upon in jurisprudence. This tool is helpful in identifying terms and phrases that may be applicable across different legal instruments.

This tool enables users to see at a glance where a particular term or phrase has been explicitly defined and/or where it has been considered in a way that illuminates its meaning. The tool may be implemented by using the tags and/or encoding embedded in the various documents in the database. By simply searching for documents which have the relevant tags which relate to the specific term or phrase being searched for, the relevant documents can be identified.

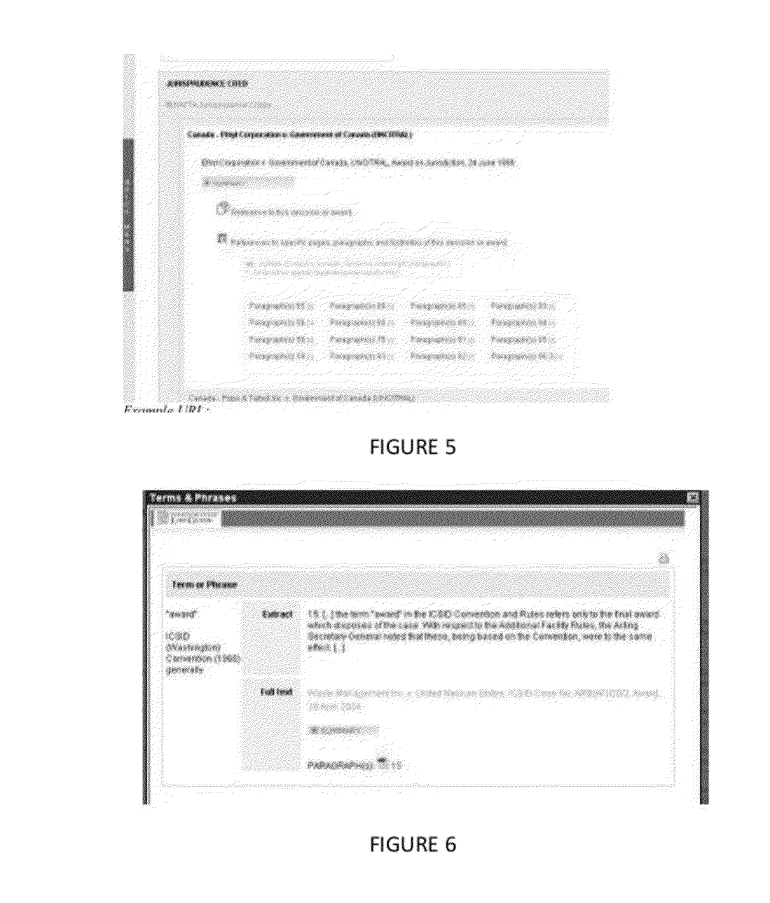

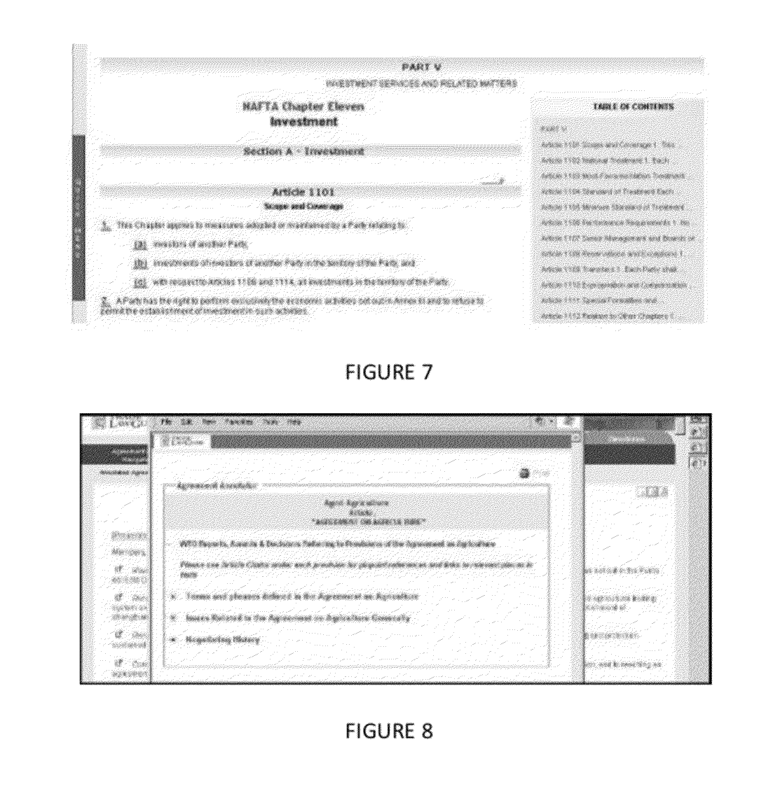

A screenshot of the user interface for this submodule is illustrated in FIG. 6.

One other submodule which may be of use to users is the “Full Text Search” submodule. This tool offers advanced and extensive full-text-search features that permit deep and comprehensive searching of the data collection following Boolean logic by use of an integrated version of a search engine along with several filters. A number of third party integrated search engines may be used.

Search results will show hit counts, with hit highlighting and accompanying PDF source files. Additionally, contextually relevant Terms & Phrases will be displayed in the right hand navigation as a suggestive alternative, which draws from the dataset and link back to relevant content.

Referring to the “Treaties & Rules” module noted above, the Treaties & Rules module provides XML formatted and coded text of secondary references. In the sample implementation, these are the agreements, laws, rules, or legal instruments or investment treaties, arbitration rules, and other relevant legal instruments. These texts are presented in a categorized format under different tabs and sub-tabs in accordance with how they are uploaded in the administration system and categorized.

The categories are predetermined based on a common format, or classification of the source document types, which are coded and uploaded as part of the workflow. A user can click on a [View PDF] button which makes use of the inline viewing specific to that section of the agreement.

Alternatively, users can view the original text of a document. This can also be accessed using a [Non-Annotated Text] link on the user interface to yield an interactive version of the document, with an inline table of contents.

Another feature of this particular system module permits administration users to annotate the XML formatted source documents and to ‘connect’ components of the document back into the other modules of the system (this is the delineation between “Non-Annotated Text” and “Annotated Text” for the link as mentioned above). Such annotations are also searchable inline of the agreement by way of a search window located above the Table of Contents menu.

In another implementation of the invention, this section is referred to as Annotated Agreements. One advantage of using such annotations is that it highlights key information. For this example implementation, FIG. 8 shows a sample agreement with annotations. In this example, the annotated agreement gives a list of all jurisprudence referring to that agreement/instrument in the form of an auto-generated report that draws data directly from the database and provides a complete list of relevant jurisprudence, a list of terms and phrases defined within the agreement (to provide a list of defined terms relevant throughout the agreement), branches indexing of issues related to the agreement/instrument generally, and the history including precursor agreements/instruments of the agreement.

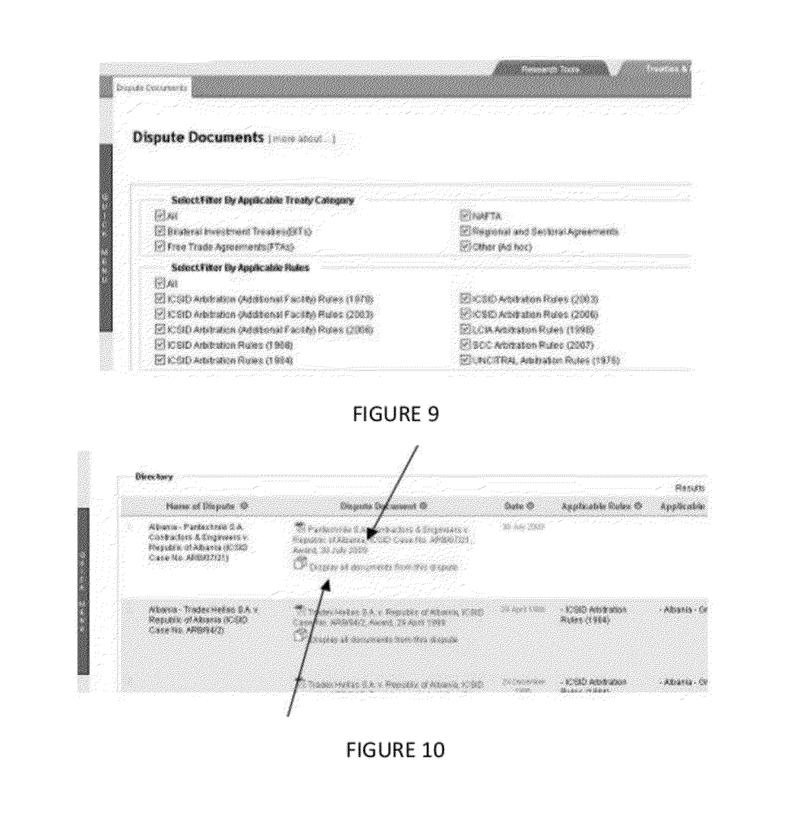

Referring to the Dispute Document module mentioned above, the dispute documents module contains the entire collection of documents currently available within the application from the database. The list of documents is displayed in a Directory type table, providing users with information relevant to the document and the underlying dispute (such as document date, applicable legal instruments, etc.) An example of the user interface used for this module is illustrated in FIG. 9. A user interface for a further section of this module is shown in FIG. 10.

To display a particular document, the user simply clicks on its citation and the document will appear in an inline PDF viewing window, immediately below the corresponding table entry. Documents are grouped by dispute and can be sorted by any of the five fields shown as column headings.

The Directory listing noted above has options for:
Selecting “Display all documents from this dispute” under the citation—this will list all publicly available documents relevant to the dispute.
Selecting “Display documents associated with this decision/award”—this option will list all documents that stem from the decision or award, which relate to issues decided by the tribunal. In this implementation, this may include separate opinions, decisions of annulment committees, decisions of reviewing courts, decisions on rectification, supplementary reasons or interpretation, and decisions on stay of execution.
Selecting “Display associated documents” will list the parent decision or award and all subsequent dispute documents that relate to issues decided in the decision. In this implementation, this may include separate opinions, decisions of an annulment committee, decisions of a reviewing court, decisions on rectification, supplementary reasons or interpretation, or decisions on stay of execution.

To assist the user in finding a specific document or document category, the Dispute Documents section includes a filtering tool and a search tool. The filtering tool allows the user to limit the documents displayed in the Directory to a specific subset of the document collection. Users are then able to click and view the relevant documents in PDF form and search the content. Filtering tools for search engines are well-known in the art and can easily be implemented by those skilled in the art.

The search module enables the user to search for documents with a specific word in its citation. The search tool works in conjunction with the filtering tool. Thus, if a filter category is selected, the search tool will only search within that category of documents.

The system of the invention preferably has an administration system that simplifies the addition and management of documents in the database as well as the exercise of the associated functions related to the documents in the database. Some attributes of the administrative-side of the administration system permit non-technical users to upload documents and alter content of the site in a simplified architecture and modular design that complements the front-end (subscribers and non-subscribers) of a site. The administration system uses top-level navigation that allows for quick links to the live and web staging sides of the site, as well as to the logout option. The content management is broken into two main categories as follows:

(i) Content Manager—consisting of the core components for content management, permitting uploading and organizing of content through tools such as the Master Tree, Document Database, Agreements/Bits. Additionally there is a tab for Web Page content for subscribers+non-subscribers.
(ii) Admin & Reports—consisting of general user management, subscriber access rights & policy management, web statistics and member reports.

As part of the Content Manager, the “Master Tree” tool is where an administrator user (perhaps a subject matter expert) creates tree/branch content for use in the database. The content of the trees, and their associated branches includes intellectually value-added data that is structured and interlinked within the rest of the database content. The Master Tree tools simplify and automate this knowledge capture exercise.

It should be noted that the content of the trees as well as their associated branches may cover the subject matter, topics, concepts, ideas, and other content that is related to the tagged/encoded material in the documents in the database. As such, documents (and their content) to be added to the database may be tagged/encoded manually or automatically such that subjects and concepts dealt with in the documents are noted in the encoding/tags for not just the documents but for the encoding/tags for the various sections of the documents.

For clarity, it should be noted that the Master Tree will have as its content the subjects, concepts, and content that relate to the documents in the database as well as the content of the documents. Each document may be associated with multiple branches, sub-branches, or node in the Master Tree. Each node in the tree (whether it is an internal node or a leaf) is matched with a concept/idea/phrase/term. Documents (or sections in documents) that relate to that concept/idea/phrase/term are then associated with that node. By having multiple documents associated with each node in the tree, traversing the tree to arrive at the node will provide the user with the relevant references (whether they be documents, sections in documents, or some other reference) related to the concept/idea/phrase/term being searched for. An administrator user using the Master Tree tool can thus prune/add/adjust the Master Tree and thereby map the knowledge tree for the subject matter of the database. Users who need to find references to certain concepts/ideas/phrases/terms merely need to find the relevant nodes in the tree. Further research in the more specific areas of that concept/idea/phrase/term can be done by travelling further down a branch from the node found. Of course, if the node is a leaf in the tree (i.e. no further branches), then the leaf is the deepest that the user can go on that concept/idea/phrase/term.

Presented as buttons at the top of the Master Tree screen, and also as a ‘floating component’ on the left of the screen which appears when selecting a node, are the tools which are used to create and manage hierarchical tree structures and related branches.

As part of the Master Tree, the buttons permit the following actions for creating branches, linking to uploaded PDF documents, linking to other branches or webpages, etc. Within the administration system branches which are marked “inactive” are displayed, selecting the [+] will expand all the child branches to the parent, and whereas selecting “ONLY” will display just the branch (and its children) in question to aid in administration.

The various options available to the administrator user for the Master Tree may be as follows:

“Add child”—adds a sub-branch (e.g. “child branch”) under the branch node which was selected

“Add level”—groups all sub-branches (e.g. child branches found under the branch node selected) under a single new sub-parent branch that gets inserted above the child branches.

“Add peer”—adds a branch following the branch node selected, where the new branch will be at the same level

“Edit/Ref.”—allows one to edit the text and settings for a branch

“Art. Cit”—this links the branch to a specific Article Citator data element

“Rpt. Gen.”—does the same as the Art.Cit option, but generates various reports using data from the document database

“Delete”—deletes selected branch and sub-branches under selected branch

“Reorder”—changes order of branches or sub-branches

“Cut+”—enables one to cut a branch and associated sub-branches and paste it elsewhere in the tree

“Copy+”—enables one to copy a branch and associated sub-branches and paste it elsewhere in the tree

“Copy+Batch”—enables one to copy a branch and associated sub-branches and paste it in multiple places in the tree

“Disp.Refs”—displays the cross-references to/from the selected branch (to see where it is linked to and which branches are linking to it).

“Art.Cit.Rpt”—displays all of the article citator data for a tree (e.g., the Anti-Dumping Agreement) and the name of the branch the article citator data is linked to. It is part of our audit to confirm that we are linking the branches to the correct article citator data.

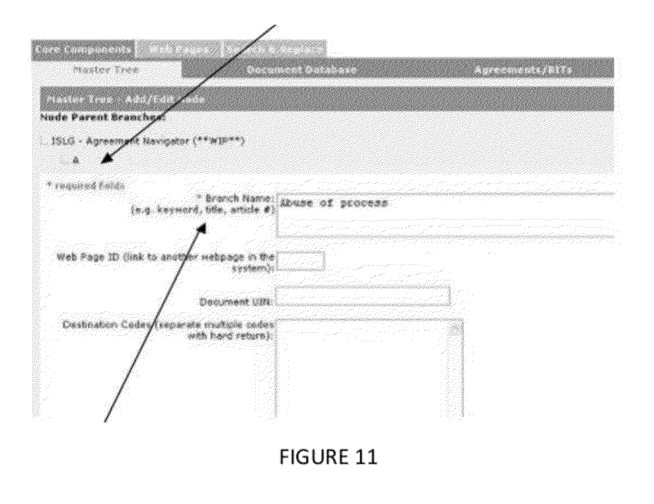

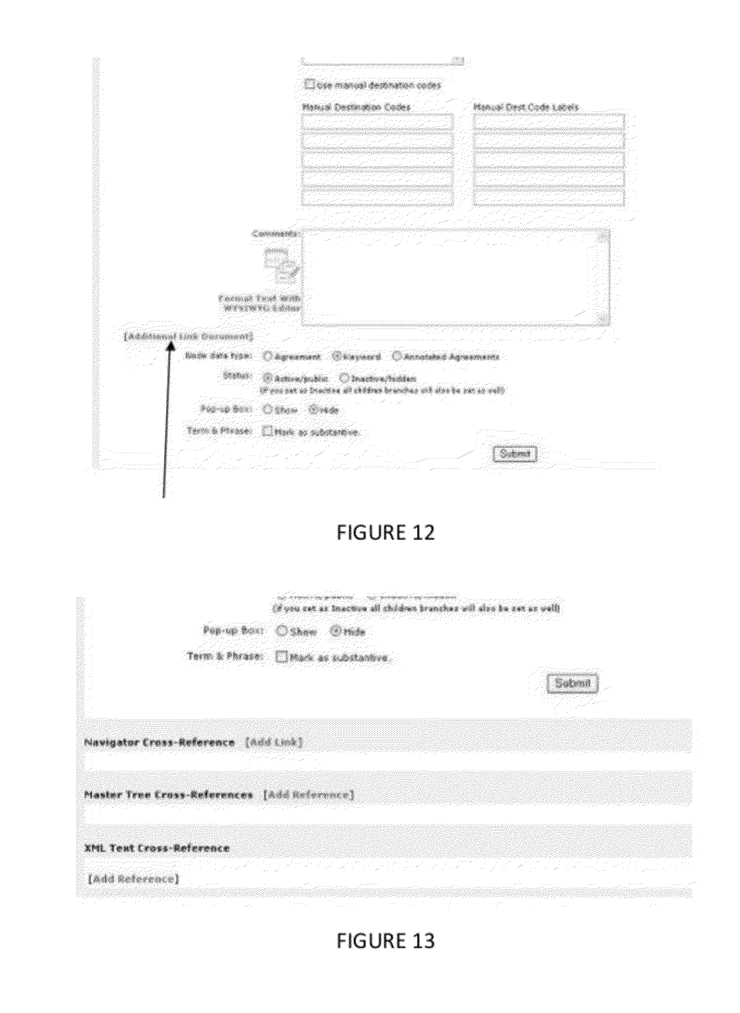

Clicking on the various editing tools above by selecting a node permits administrator users to modify and add branch content to the subscriber side of the Navigator while viewing where they are within the overall tree. The fields in the user interface for this part of the system are illustrated in FIGS. 11, 12, and 13 and are listed as follows:

Branch Name—this is the title of the section/branch in a preformatted manner. Currently HTML tags can be used for subscriber side formatting. (e.g. <EM> <B> etc.)

Web Page ID—providing the ID on the subscriber-side page associated with an access server if known, it can be added here and the link would be an HREF to that page within the website

Document UIN:—if there is a specific case which is being cited, then the associated PDF Document UIN needs to be entered so that the inline PDF viewer knows to call which PDF document for display

Destination Codes:—as part of the aforementioned PDF, if there are specific destination codes which are to be used for display and linking as part of the inline viewer in the Navigator on the subscriber side, this is where such codes are manually entered.

Manual Destination Codes & Labels—this is a special function used for complicated documents in the event the automated destination codes do not work.

Comments—this contains content used on the “extracts” box displayed on the live site

[Additional Link Document]—recreates the Document UIN, Destination Codes through Comments Sections to permit multiple links to be added to a single branch entry.

Node Data Type:—this separates the entry as being three data types as part of the system. In one implementation, there are 3 branch types (i) Master Tree Feeding AA, (ii) Agreement Navigator, and (iii) Annotated Agreements. Other branch types and other numbers of branch types are also possible.

Status:—If the branch is marked “Active” it is displayed. If it is marked “Inactive” it is hidden along with all child branches below.

Term & Phrase: This adds the entry to the Terms & Phrases module as described above

Following the main section of the Master Tree content manager, there may be additional options for adding links and references to the specific branches. In one implementation, three additional options are provided and these include:

Navigator Cross-Reference—this permits a cross-reference in Navigator to another Navigator entry. The functional component of this allows an admin user to click on this, and the master tree directory hierarchy is displayed with an option to “link” to other specific navigator branches. In the event multiple entries needed to be linked, the [add link] button can be selected to permit another link.

Master-Tree Cross Reference—The master-tree cross-reference is used to link to any other branch in the master-tree, allowing multiple-references. It should be noted that the Navigator Cross-Reference above is something specific to link navigator branches and only allows one branch to be linked.

XML Text Cross-Reference—used to link to an XML document, or a specific destination/location in an XML document.

Another core component of the Content Manager is that of the Document Database. The document database is the main workflow tool in the application, enabling administration users to
upload documents (depending on different document types),
classify documents using relevant fields, and
associate components of documents to various data within the system for search and display.

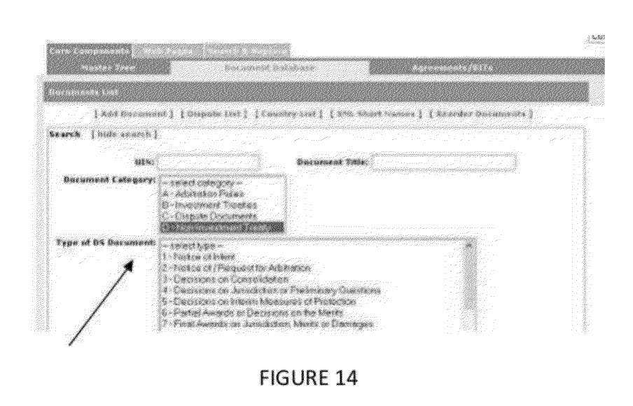

Referring to FIG. 14, a screenshot for this core component is illustrated. The top of the window has a search option which permits searching of the UINs (with an auto complete feature) as well as search by document title, or a list located below the main module window. This information that trails shows a summary of status (active/inactive), last modified date, the UIN, the category, if the content has been verified, how to edit, delete, access the PDF (which was uploaded) etc.

This Document Database module is designed such that all necessary data is gathered and workflow is monitored/tracked when each document is uploaded.

As part of the multi-step upload process, drop down menus, suggestive autocomplete fields, process steps/stages (change/update/nochange/etc) and content-specific fields are used to enable upload by administrator users.

The user interface for this section of the system has the following top level options:

[Add Document]—this option starts the workflow process for uploading new documents

[Dispute List]—allows for the additon/editing/deletion of names of disputes in the database, and where the UIN identifier where added disputes need to have the associated numbers displayed.

[Country List]—this option allows administrator users to edit the list of countries for the drop down menus in the document upload process

[XML Short Names]—the entries for this section are short names to be assigned to the XML coded syntax tags. These tags can be used to create global provision descriptions to supplement the Edit Provisions Descriptions tool.

[Reorder Documents]—where the display side of the documents can be reordered manually, and within their categories.

It should be noted that it is preferable that documents be uploaded in stages with the stages determining the relevant content/fields that must be completed in the next stage. Uploading documents in stages can assist administrator users in document upload and quality assurance).

Document categories may be used so that documents in different categories may be treated differently. The document categories are assigned based on the nature of the content and what is required in the upload process. In one implementation, the categories are:

Category A—“Arbitration Rules”

Category B—“Investment Treaties”

Category C—“Dispute Documents”

Category D—“Non-Investment Treaties”

The upload process is separated into several steps. First, the initial upload should occur while highlighting key information (such as title and unique identifier), the document category (which will apply relevant follow-on steps) and the steps for the upload workflow.

The various categories and their handling are as follows:

Category A—Arbitration Rules

This content of this type of document is intended for upload to the Treaties & Rules tab located on the subscriber side of the site. Documents in this category have XML related content and comprise relevant source files.

Uploading this category of files is done in 2 steps with their relevant steps being listed:

STEP1: Assigning the UIN, the title of the document, language of the file, the associated PDF source file is part of Step1. Additional details, such as last modified date and metadata related to the document to help with the module search tools (e.g. ICSID may also be “I.S.C.I.D” or “ICSID 84”, are also collected in this step.

STEP2: A short name can be applied, and other relevant information is collected in this step. Additionally, the list of provisions where the uploaded XML document is specified and a ‘scraping’ occurs of the XML schema applied, outlining the provisions of the agreement. This action of obtaining the list of provisions is performed upon upload when the relevant treaty/rule is identified], and the button is selected and the list appears.

In one implementation, an [edit provision descriptions] option is present. When this is selected, there is an inline editor which will allow for the editing of short names as well as the associated ordering of those provisions.

Category B—Investment Treaties

For Category B documents, the first step is the same as that for Category A documents.

For Category B documents, the STEP2 process has a slight modification of fields given the unique nature of that particular document collection. As examples of differences in content between the specified categories of documents:

(i) Category B document uploads provide an option for a “type of treaty” which reflects sub-categories on the subscriber side to group the content on the subscriber side.
(ii) Category B uploads also have a section for “parties to a treaty” which need to be specified on upload. Multiple countries can be selected from this list and is used as part of a search. This list content is editable and derived by the [Country List] field in the main module window

Of course, other implementations of the various categories may use different classifications and different steps when uploading different documents.

Category C—Dispute Documents

Category C documents, in addition to dispute documents, also include various citators, extracts, terms & phrases and more.

Following a similar STEP process as with Category A and B documents, Category C documents are preferably specially tagged/encoded PDF source documents which contain a unique coding instruction that places destination code references within the PDF files which are referred to within the application.

As part of STEP1, all details regarding the documents being uploaded are added. Also uploaded are accompanying PDFs that have lists of destination ‘anchor codes’ which are inserted by administrator users in a specific format and as part of a list coming from an spreadsheet. These can be edited or added after the fact if a document is recoded.

As part of STEP2, key information is added to the uploaded Category C document to help with indexing, and within the workflow process, summary information is provided.

Additionally, the “Type of Document” is specified to help with the sorting and organizing as part of the classification data used in filters of the website, including the Dispute Documents module.

For this category of documents, STEP3 is used as part of the upload process. In STEP3, additional information regarding the documents being uploaded is collected. Information such as names of arbitrators, summary extract information, article citator information, jurisprudence referred to, terms and phrases, damages, costs, etc. is collected along with associated reports. Collection of this information will allow the relevant links to appear in the database for audit purposes.

The above noted Article Citator link in this STEP3 is for “Treaties and Articles referred to” and is what populates the modules on the main navigation. This information is captured in an external tool (internal “DCD”=Data Capture Document process) and manually entered and uploaded. Similar to the Jurisprudence Referred to link, this upload occurs following a predetermined format.

Clicking on the Edit option shows the various the upload process fields for the data entry. Where country information is selected specific to the entry, the relevant agreement, the articles/provisions referred to, relevant destination codes where such information is called from or cited (as per the internal DCD=Data Capture Document) as well as extracts are available for edit once the Edit option is activated.

Category D—Non-Investment Treaties

Similar to Category A and Category B documents, these Category D documents contain similar XML linked information. The first step to uploading these documents is that of setting up the relevant fields pertaining to the document.

The second step is that of identifying the relevant dispute and citation and permits the administrator user to update the content.

Another core component of the Administration System is the Agreements/Bits module which enables administrator users to edit and upload XML versions of PDF documents, add annotations to the XML schema, and create links between the annotation links and the branches in the MasterTree.

Once the documents are uploaded, the documents are then used as part of the Document Database upload process where the XML content is scraped and digested into the workflow for reference of specific paragraphs. This module permits the ability to upload the XML document, make live, and edit the XML if required. XML converted documents and their associated titles are uploaded and put into the system.

Once uploaded, administrator users can make the file live (i.e. available to be accessed by regular users), and have the ability to edit the XML document. Editing will require the user to activate an [edit] option on the user interface. These editing tools consist of an additional pop-up window with a raw Javascript XML editor with syntax highlighting.

To automatically generate usable XML documents using this module, the XML document is first uploaded. The module then starts tagging the XML document by putting the pre-defined schema/tags in the document. The predefined schema ensures that the XML document is usable by the system. Of course, the schema may differ from implementation to implementation. When the XML document is saved into the application it will search some of the schema tags and add an attribute “kyid” to each tag so that it will be unique.

To generate a list of provisions for each document, the system reads all schema tags to generate a list of provisions that will be stored in the “List of provisions” section in the same page. Only provisions that are not on the list will get added when clicking “Get List of Provisions” button.

Regarding user accounts and user management, the system uses regular web-based subscriber management methods. Users are allowed to sign-up to access the system's more useful features. User sessions may be tracked along with logins, IP (Internet Protocol) addresses, and if it was a blocked attempt or not. User accounts can be corporate, government, group, or individual.

One feature of the system's user management subsystem is the ability to permit auto-login based on IP address ranges. To permit auto-login, administrator users can submit a range of IP addresses, or a single IP address and then check off “Auto-login” in the subscription process. To add more IP addresses, the administrator user simply selects an “Add IP Range Permission” option in the user interface for this section.

Another feature of the subscriber section of the system is the presence of two relevant tools: the IP Choke and IP Auto-Access tools.

The IP Choke tool is used to choke the IP address access so the username/password only works when the database is accessed from a particular IP address or range.

The IP Auto Access tool is used for large subscribers to access the site without having to use a username/password. This may be used primarily for universities and for large commercial subscribers who want to auto-login for anyone accessing the database from a specific IP address or IP address range. Anyone accessing the system from the specific IP address or IP address range will be logged in automatically without the need to enter a user/password combination.

Throughout the system, the user is able to view stored PDF documents using an integrated frame with specific destination codes (inserted to within the document collection). These also act as anchors and can be called on to display with the exact location of the link, and as an inline frame or “iframe”. This permits users to browse from a system (or website) index to specific and original text of jurisprudence as part of the document set. In one implementation, the inline PDF browser uses Acrobat Reader 7.0+. Other implementations may use a proprietary AJAX viewer.

Regarding the search capabilities of the system, each Research Tool module (except Full Text Search given it is much more extensive), as well as some other modules, has a “Search for a particular agreement or instrument” option where such search permits a full text search of the content associated within that section.

This search module has suggestive search capabilities that draw from the titles of the modules, as well as specific content found in the tools (e.g. ADM is the title of a case, as part of the index of content within the Article Citator module), as well as through spelling and various word combinations. This search field can be advanced, or used in conjunction with other search tools implemented in the system.

The search tools also have hit-highlighting along with search results, with such results being clickable/activatable based on the output, and once clicked/activated will take the user to the links in the specific tools as per the search criteria. Such search tools consider synonyms, fuzzy typo, and spelling variations (including meta data which is added in the document upload process, and is tagged by administrator users per document to be associated with the content (e.g.: Ch11 vs. Chapter11 vs. ChapterEleven etc.)

The system architecture used for the access servers is based on a structure of applications and programming logic on an N-tier framework (preferably implemented using ASP.NET MVC).

The term “N-tier” implies any number of distinct tiers used in the architecture itself where each tier can be defined as one of two or more rows, levels, or ranks arranged one above another each serving their own distinct and separate tasks. These tiers have been implemented using a separate subsystem for each of the various tiers. The tiers have been separated into four layers including, presentation, business, data access and the data tier itself. The subsystems, tiers, and their functions are as follows:
Presentation subsystem is the layer responsible for displaying the user interface and driving that interface using business tier classes and objects.
Business subsystem is the layer responsible for accessing the data tier to retrieve, modify and delete data to and from the data tier and to send the results to the presentation tier. This layer consists of business logic (BLL) and is found above the data access layers.
Data Access subsystem is also responsible for processing the data retrieved and sent to the presentation layer. The Data Access Layer (DAL) is responsible for accessing data and forwarding it to BLL.
Data subsystem is the database or the source of the data itself. Often in .NET format, this subsystem is the SQL database or XML repository.

The use of this architecture provides true separation, and containment of modules of application code. With this system architecture, the business logic does not rely on the reactions that occur from the processing. Other benefits include simpler system upgrades due to the modularity of the design.

It should be noted that the system described above is for a legal document based database that provides functionality and tools designed specifically for legal research and, even more specifically, for legal research covering international trade law. However, similar tools may be used for other legal research implementations as most of the concepts used in the system design to assist international trade law research are directly transferrable to other legal fields. As well, it should also be noted that the above noted system can be customized for use with any document based database. Search tools similar in concept if not in execution to those described above may also be used for other implementations that deal with other, non-legal bodies of knowledge.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A system for managing and accessing a plurality of documents by way of an interconnected network of computers, the system comprising:
a plurality of groups of access servers, each group of access servers being for providing access to organized documents to different groups of subscribing users;
a single storage database for storing said documents, said single database being accessible by each of said groups of access servers;
wherein
a plurality of said documents being tagged to identify specific sections of said documents said sections being relevant to various topics of research for said subscribing users.

2. A system according to claim 1 wherein at least one access server comprises:
a presentation subsystem for displaying a user interface to users;
a data access subsystem for processing data and documents retrieved from said database prior to being forwarded to said presentation subsystem; and
a business based subsystem for retrieving and modifying documents and data from said database and for forwarding said documents and data to said data access subsystem.

3. A system according to claim 1 wherein tags for said specific sections are organized in said database for ease of searching by said users.

4. A system according to claim 3 wherein topics used to organize said tags are organized in a nested, hierarchical manner.

5. A system according to claim 1 wherein said documents include legislation.

6. A system according to claim 1 wherein said documents include legal agreements.

7. A system according to claim 1 wherein a plurality of documents are annotated with comments from experts in a subject matter to which said documents pertain.

8. A system according to claim 1 wherein said documents include case law.

9. A system according to claim 4 wherein said topics are cross-related to one another.

10. A system according to claim 9 wherein said topics are cross-related in a contextual manner.

11. A system for managing and providing access to a plurality of documents for a plurality of users, the system comprising:
a presentation subsystem for displaying a user interface to users;
a data subsystem for storing and managing a database of said plurality of documents;
a data access subsystem for processing data and documents retrieved from said data subsystem prior to being forwarded to said presentation subsystem; and
a business based subsystem for retrieving and modifying documents and data from said data subsystem and for forwarding said documents and data to said data access subsystem;
wherein
a plurality of said documents being tagged to identify specific sections of said documents, said sections being relevant to various topics of research for said users.

12. A system according to claim 11 wherein said user interface presents available topics to said users in a hierarchical manner.

13. A system according to claim 12 wherein said user interface displays said topics in a nested and hierarchical manner.

14. A system according to claim 12 wherein said topics are cross-referenced to other related topics.

15. A system for managing and accessing a plurality of legal documents by way of an interconnected network of computers, the system comprising:
a plurality of groups of access servers, each group of access servers being for providing access to organized legal-related documents to different groups of subscribing users;
a single storage database for storing said documents, said single database being accessible by each of said groups of access servers;
wherein
a plurality of said documents are tagged to identify specific sections of said documents, said sections being relevant to various topics of legal-related research for said subscribing users.

16. A system according to claim 15 wherein at least one of said access servers provides said users with a subject navigator search tool for use in accessing said database, said subject navigator search tool being for displaying highly structured and organized legal-related subject matter to said users.

17. A system according to claim 15 wherein at least one of said access servers provides an article citator search tool to said users, said article citator being for searching said database for documents related to specific legal provisions being researched by said users.

18. A system according to claim 17 wherein said documents being searched for by said article citatory includes at least one of law cases, decisions by tribunals, legal agreements, and legal opinions.

19. A system according to claim 15 wherein at least one of said access servers provides a jurisprudence citator search tool to said users, said jurisprudence citator being for searching said documents in said database which have content related to a specific concept, said documents comprising tribunal decisions, law cases, and documents from decision-making entities.

20. A system according to claim 15 wherein at least one of said access servers provides a search tool for said users for researching legal-related terms or phrases, said search tool being for finding documents in said database which have content that is helpful in determining a meaning of said terms or phrases.

21. A system according to claim 15 wherein documents to be added to said database are pre-sorted for subject and matter classification prior to being uploaded to said database.

22. A system according to claim 15 wherein documents to be added to said database are pre-sorted for content classification prior to being uploaded to said database such that a document's content is tagged for specific subjects.

23. A system according to claim 15 wherein at least one of said access servers utilizes a taxonomy tree to organize concepts covered by said documents in said database, said taxonomy tree having nodes for each concept covered by at least one document with branching nodes for more detailed treatment of said concepts.

24. A system according to claim 23 wherein each document in said database is mapped to at least one node in said tree.
